(19) United States
(12) Patent Application Publication
(10) Pub. No.: US 2009/0244781 A1
(43) Pub. Date: Oct. 1, 2009

(54) MAGNETIC HEAD SLIDER AND MAGNETIC DISK DRIVE

(75) Inventors: Takahiro Imamura, Kawasaki (JP); Hiroyuki Kubotera, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/409,011

(22) Filed: Mar. 23, 2009

(30) Foreign Application Priority Data
Mar. 27, 2008 (JP) 2008-083398

(51) Int. Cl. G11B 5/60; B44C 1/22

(52) U.S. Cl. 360/235.4; 216/22

(57) ABSTRACT

A magnetic head slider includes a magnetic head element for reading or writing data from or into a magnetic recording medium. The magnetic head slider flies over the magnetic recording medium by an air flow generated by rotation of the magnetic recording medium. The magnetic head slider includes a slider substrate including a center pad for supporting the magnetic head element, the center pad having a sliding surface opposing the magnetic recording medium and a side surface at a downstream side of the air flow, the slider substrate including a concave portion having a bottom surface recessed from the sliding surface; and an insulating layer covering the side surface of the slider substrate, the insulating layer having an edge surface adjacent to the bottom surface of the concave portion, the edge surface having substantially the same plane with the bottom surface of the concave portion.

### CROSS-REFERENCE TO RELATED APPLICATIONS

This application is based upon and claims the benefit of priority of the prior Japanese Patent Application No. 2008-083398, filed on Mar. 27, 2008, the entire contents of which are incorporated herein by reference.

### FIELD

The embodiments discussed herein are related to a magnetic disk device.

### BACKGROUND

With an increase in recording density of a magnetic disk device, it is necessary to reduce the distance between the magnetic head and the magnetic disk when the magnetic head operates while flying above the magnetic disk. For reducing the distance between the magnetic head and the magnetic disk, it is necessary to reduce flying height of the head slider on which the magnetic head is mounted. Flying heights of head sliders in recent magnetic disk devices have been reduced down to 10 nm or less.

In the head slider of the magnetic disk device, concave portions (referred to also as grooves) are installed on a surface thereof in order to adjust the flying height and ensure stability during flying (for example, refer to Japanese Laid-open Patent Publication No. 2004-55127). When air flow generated by rotation of the magnetic head flows along the concave portions, a moderate static pressure occurs. This allows the head slider to stably fly while maintaining a predetermined distance above the magnetic disk.

Typically, on the surface of the magnetic disk, a lubricant (for example, perfluoropolyether (PFPE) oil) is applied for protecting the head or the disk from failure due to incidental contact between the magnetic disk and the head slider. While this lubricant is liquid, it has a comparatively high viscosity. Therefore, although the magnetic disk is rotating at a high speed, the lubricant adheres to the surface of the magnetic disk in a film state. As a result, the head slider flies above a coating of the lubricant on the magnetic disk.

If the distance between the head slider and the magnetic disk device, i.e., flying height is reduced, there occurs a possibility that the head slider makes contact with the lubricant to thereby make a minute amount of the lubricant adhere to the surface of the head slider. Furthermore, vaporized lubricant may make contact with the surface of the head slider and condense, whereby the lubricant may adhere to the surface of the head slider.

The adhered lubricant flows along the slider surface under various forces acting on the surface, and forms various patterns, thus generating a phenomenon called oil spot. That is, if there is a region on which shear stress acting on the surface due to air flow flowing along the slider surface concentrates, the lubricant will get together in the region.

If a liquid drop that has thus built up and grown to some extent leaves from the slider and falls onto the magnetic disk (i.e., onto the coating of the lubricant), then, the just fallen liquid drop of the lubricant forms a protruded shape on the coating of the lubricant on the magnetic disk. When the magnetic disk has rotated one revolution and the fallen lubricant has returned to the position of the head slider, the head slider can collide against the fallen lubricant. In addition, such fallen lubricant also causes fluctuation of the flying height of the head slider.

That is because the magnetic disk is rotating at a high speed and the lubricant has a high viscosity and therefore, the lubricant that has fallen onto the magnetic disk and formed a protruded shape rotates one revolution before it returns to the original flat state.

In this manner, if there exists fallen lubricant on the magnetic disk, in the worst case, the slider could suffer a failure under an impact of the collision. Furthermore, due to fluctuation of the flying height, read/write error becomes prone to occur. Such a problem becomes more significant as the distance between the magnetic head and the magnetic disk becomes smaller.

### SUMMARY

According to an aspect of the invention, a magnetic head slider including a magnetic head element for reading or writing data from or into a magnetic recording medium, the magnetic head slider flying over the magnetic recording medium by an air flow generated by rotation of the magnetic recording medium, comprises a slider substrate including a center pad for supporting the magnetic head element, the center pad having a sliding surface opposing the magnetic recording medium and a side surface at a downstream side of the air flow, the slider substrate including a concave portion having a bottom surface recessed from the sliding surface; and an insulating layer covering the side surface of the slider substrate, the insulating layer having an edge surface adjacent to the bottom surface of the concave portion, the edge surface having substantially the same plane with the bottom surface of the concave portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a magnetic disk device according to an embodiment;

FIG. 2 is a side view of a magnetic head slider in FIG. 1;

FIG. 3 is a perspective view of an air bearing surface of a magnetic head slider proposed in our earlier applications;

FIG. 4 is an explanatory view of Couette flow illustrated in FIG. 3;

FIG. 5 is an explanatory view of a pressure distribution in the configuration illustrated in FIG. 3;

FIG. 6 is a vector diagram illustrating the direction of a shear stress on the air bearing surface illustrated in FIG. 3;

FIGS. 7A to 7D are explanatory views of a manufacturing process of the magnetic head slider illustrated in FIG. 3;

FIG. 8 is an etching process in FIGS. 7A to 7D;

FIG. 9 is a top view of a magnetic head slider manufactured by the manufacturing method in FIGS. 7A to 7D;

FIG. 10 is a sectional view of the magnetic head slider manufactured by the manufacturing method in FIGS. 7A to 7D;

FIG. 11 is a vector diagram illustrating a direction of shear stress on the air bearing surface of the magnetic head slider manufactured by the manufacturing method in FIGS. 7A to 7D;

FIG. 12 is an explanatory view of a first etching process according to the first embodiment;

FIG. 13 is an explanatory view of a second etching process according to the first embodiment;

FIGS. 14A to 14E are explanatory views of a manufacturing process of a magnetic head slider according to the first embodiment;

FIG. 15 is a top view of the magnetic head slider manufactured by the manufacturing method in FIGS. 14A to 14E;

FIG. 16 is a sectional view of the magnetic head slider manufactured by the manufacturing method in FIGS. 14A to 14E;

FIG. 17 is an explanatory view of a first etching process according to a second embodiment;

FIG. 18 is an explanatory view of a second etching process according to the second embodiment;

FIGS. 19A to 19E are explanatory views of a manufacturing process of a magnetic head slider according to the second embodiment;

FIG. 20 is a top view of a magnetic head slider manufactured by the manufacturing method in FIGS. 19A to 19E;

FIG. 21 is a sectional view of a magnetic head slider manufactured by the manufacturing method in FIGS. 19A to 19E;

FIG. 22 is a vector diagram illustrating a direction of shear stress on the air bearing surface of the magnetic head slider manufactured by the manufacturing method in FIGS. 19A to 19E;

FIG. 23 is a perspective view of a magnetic head slider according to a third embodiment;

FIG. 24 is an explanatory of operations in the third embodiment; and

FIGS. 25A to 25E are explanatory views of a manufacturing process of a magnetic head slider according to a third embodiment.

### DESCRIPTION OF EMBODIMENTS

Hereinafter, the present invention is described in the order of configurations of a magnetic disk device and a head slider, a first embodiment, a second embodiment, a third embodiment, and other embodiments. The present invention is not limited to these embodiments.

### [Magnetic Disk Device]

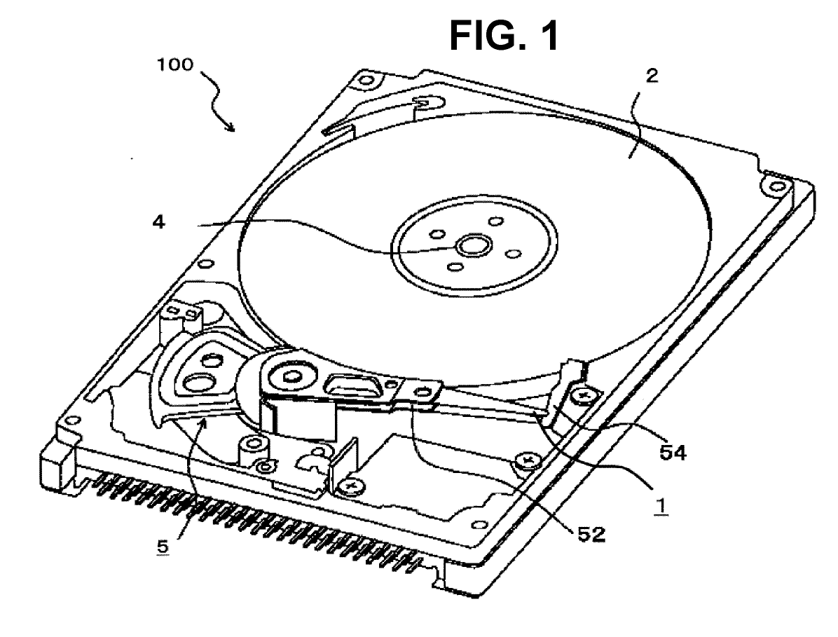

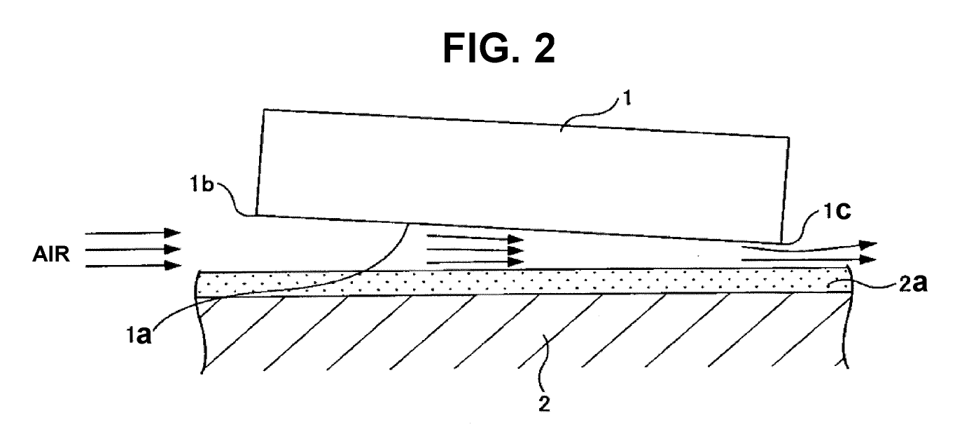

FIG. 1 is an external view of a magnetic disk device according to an embodiment, and FIG. 2 is an explanatory view of the magnetic head slider in FIG. 1. FIG. 1 exemplifies a hard disk drive as a magnetic disk device.

As illustrated in FIG. 1, in a disk enclosure (referred to as DE) 100, a magnetic disk 2 serving as a magnetic recording medium is fitted to rotating shaft of a spindle motor 50. The spindle motor 50 rotates the magnetic disk 2. An actuator (referred to as VCM) 56 has an arm 52, and a magnetic head slider 1 arranged at the front end of a suspension, and moves the magnetic head slider 1 to a radial direction of the magnetic disk 2.

The actuator 56 is constituted of voice coil motor (VCM) that rotated about a rotating axis. In FIG. 1, one magnetic disk 2 is mounted on the magnetic disk device, and two magnetic head sliders 1 are simultaneously driven by the identical actuator 56.

The magnetic head slider 1 includes a read element and write element. The magnetic head slider 1 is configured by stacking the read element including a magnetic resistance (MR) on the slider, and thereon, stacking the write element including a write coil.

Outside of the magnetic disk 2, there is provided a ramp mechanism 54 for retracting the magnetic head slider 1 from the magnetic disk 2 and parking it.

In a lower portion in FIG. 1, a printed circuit assembly (control circuit portion) is provided. The printed circuit assembly includes a hard disk controller (HDC), a microcontroller (MCU), a read/write channel circuit (RDC), a servo control circuit, a data buffer (RAM), and a ROM (read-only memory).

As illustrated in FIG. 2, the magnetic head slider 1 is configured to write a magnetic signal in the magnetic disk 2 by a magnetic head element (not illustrated) while flying above the magnetic disk 2 serving as a recording medium, and read the magnetic signal recorded in the magnetic disk 2. The magnetic head slider 1 is a small-sized magnetic head having, for example, a width of 1 mm, a length of magnetic head slider 1.2 mm, and a thickness of 300 μm, and has an air bearing surface 1a opposed to the magnetic disk 2. On the surface of the magnetic disk 2, a coating 2a of the lubricant is formed.

The magnetic head slider 1 is configured to be flown by air flow generated by the rotation of the magnetic disk 2. During flying of the magnetic head slider 1, a leading edge 1b of the air bearing surface 1a of the magnetic head slider 1, that is, a side on upstream side as far as the direction of air flow is concerned, is located higher than a trailing edge 1c of the air bearing surface 1a of the magnetic head slider 1, that is, a side on upstream side as far as the direction of air flow is concerned. Therefore, the magnetic head slider 1 flies above the magnetic disk 2 in a state wherein the trailing edge 1c is the nearest to the magnetic disk 2. During flying, the magnetic head element is mounted in the vicinity of the trailing edge 1c located near the magnetic disk 2. Since the air flow along the air bearing surface 1a flows out from the trailing edge 1, the trailing edge 1c is also referred to as a “downstream” end. Hereinafter, “front” means an upstream side along an axial direction of the head slider with respect to the air flow, while “rear” means a downstream side along the axial direction of the head slider with respect to the air flow.

### [Configuration of Head Slider]

Japanese Patent Applications Nos. 2006-354142 and 2007-71639 (corresponding to US Patent Application Publication No. 2008158716) are incorporated herein by reference. Configurations of a magnetic head slider having a novel lubricant flowing surface are described below.

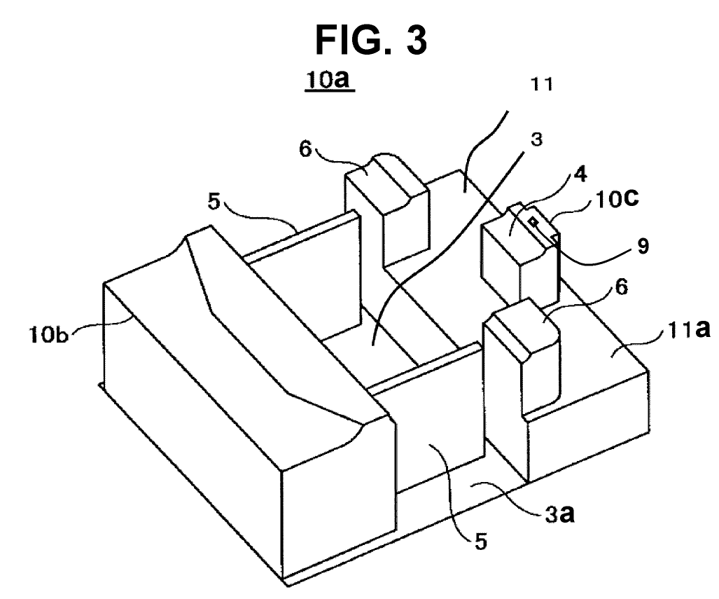

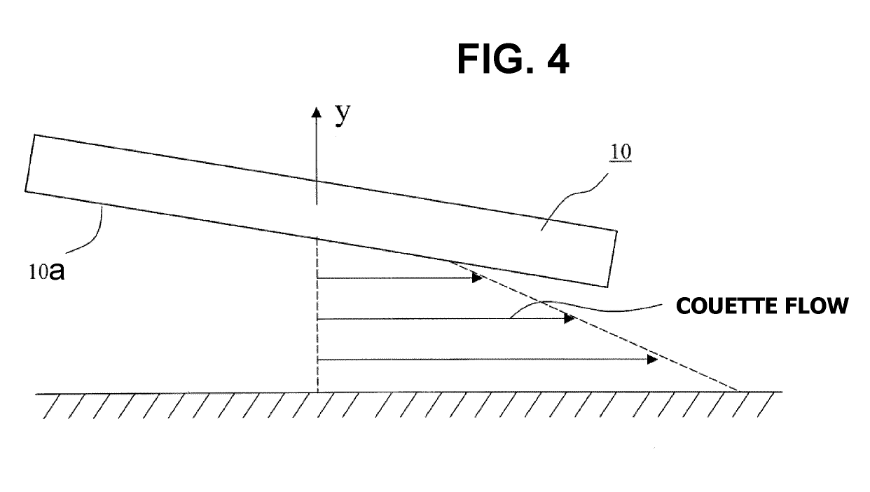

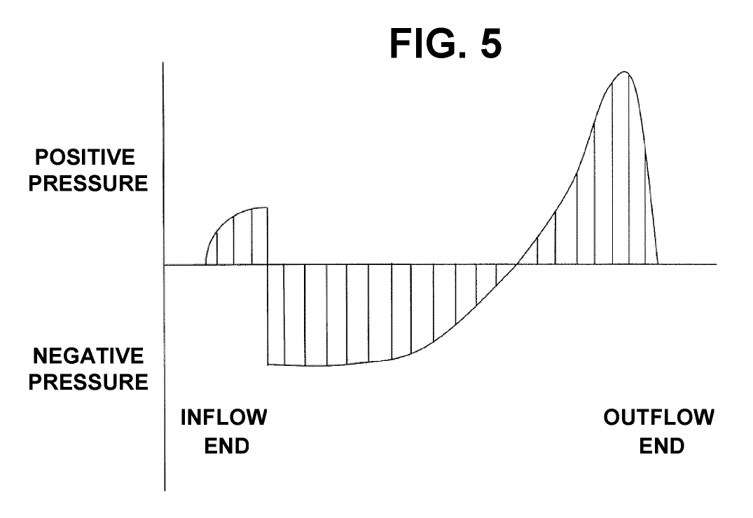

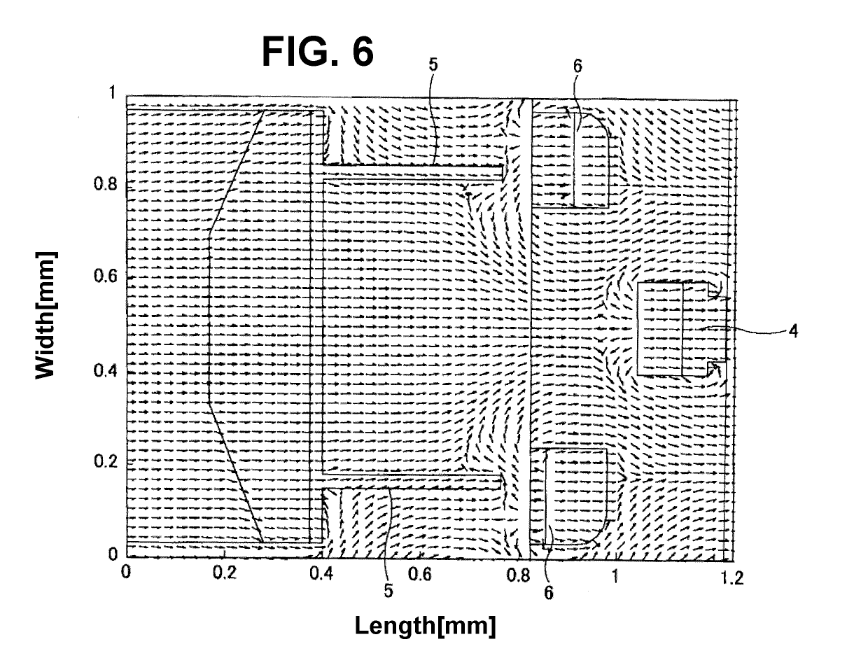

FIG. 3 is a perspective view of a magnetic head slider proposed in the above-described our earlier applications; FIGS. 4 and 5 are explanatory views illustrating its operations; and FIG. 6 is a vector diagram illustrating a shear stress vectors by air flow on the air bearing surface in the configuration in FIG. 3.

FIG. 3 is a perspective view illustrating the side of the air bearing surface 10a of the magnetic head slider 1. On the air bearing surface 10a, convex and concave portions for controlling air flow are formed. On the surface of the magnetic head slider 1, by forming concave portions (also referred to as grooves), convex and concave portions are formed. In FIG. 3, the dimensions thereof in a vertical direction (i.e., depths of the concave portions or grooves) are enlarged with respect to the actual dimensions for the convenience of illustration. For example, if the dimensions of the magnetic head slider 1 are 1 mm in width and 1.2 mm in length, then, the depths of bottom surfaces of the concave portions are on the level of 1.5 to 2.0 μm.

On the side of the leading edge 10b of the air bearing surface 10a of the magnetic head slider 1, no concave portion is formed. On the trailing edge 10c, a concave portion 3 is formed. By forming the concave portion 3, a portion protruded from the bottom surface 3a of the concave portion 3 is formed. This protruded portion includes two side wall portions 5 formed along the lengthwise direction, in the vicinity of the side surfaces of the magnetic head slider 1. The air bearing surface 10a has a concave portion (first concave portion) 11 besides the concave portion (second concave portion) 3. The depth of the bottom surface 11a of the first concave portion 11 is smaller than that of the bottom surface 3a of the second concave portion 3, resulting in concave portions formed into a two-level configuration.

In the portion protruded from the bottom surface 11a of the first concave portion 11 in the trailing edge 10c, there are provided a center pad 4 (first convex portion) formed at a widthwise central position of the magnetic head slider, and two side pads 6 formed at a positions behind the side wall portions 5. On the inflow side of each of the leading edge 10b, the center pad 4 and the side pads 6, a shallow groove with a depth on the level of 0.1 to 0.3 μm is provided as appropriate. These shallow grooves have a function of generating a strong pressure on the top surfaces of the leading edge 10b, the center pad 4, and the side pads 6.

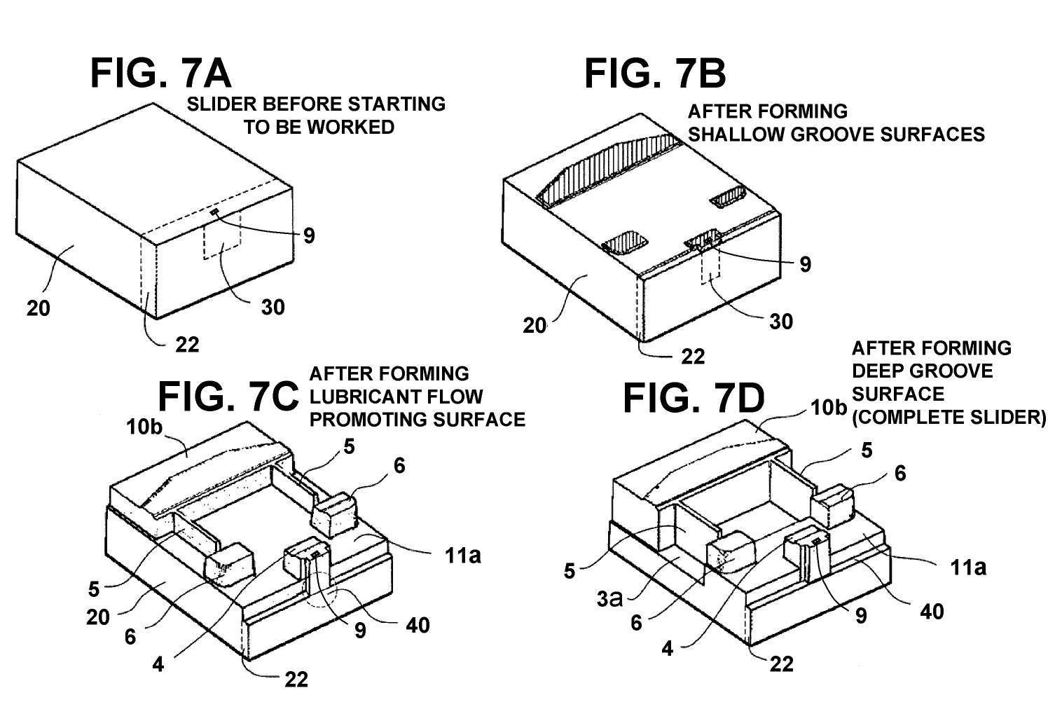

The center pad (first convex portion) 4 is located in the vicinity of the trailing edge 10c, and in the neighborhood of the surface thereof, the center pad 4 is equipped with a magnetic head element 9. The magnetic head element 9 is enlarged disproportionally with respect to the center pad 4 in FIG. 3. The magnetic head element 9 is also enlarged in FIGS. 7A to 7D, 14A to 14E, 19A to 19E, 23 and 25A to 25E. The side pads (second convex portions) 6, which are located in the vicinity of the both side surfaces in a rear side in the magnetic head slider 1, is installed for stabilizing the posture of the magnetic head slider 1 during flying. The side wall portions 5 are installed for defining a space roughly in the center of the magnetic head slider 1. When air flow enters in this space, a negative pressure generates in the space, and there occurs a force for pressing down the magnetic head slider on the magnetic disk 2 with a moderate pressure.

That is, the concave portion (second concave portion) 3 is arranged on the front side of a line connecting the front surfaces of the two side pads 6, and the bottom surface 11a of the concave portion (first concave portion) 11 is arranged over the entire rear side of the line connecting the front surfaces of the two side pads 6. Therefore, the bottom surface 11a of the first concave portion 11 is formed so as to surround the side pads 6 and the center pad 4. In other words, the center pad 4 and the side pads 6 are arranged within the first concave portion 11, and protrude from the bottom surface 11a.

As illustrated in FIGS. 4 and 5, at the leading edge (inflow end) 10b, the slider is given an air bearing force by a positive pressure, and at the first and second concave portion 11 and 3, the slider is given a negative pressure for pressing it down on the magnetic disk 2. Then, at the center pad 4 located on the downstream end side, and at the side pads 6, the slider is given an air bearing force by a positive pressure to thereby maintain its posture.

As illustrated in FIG. 4, Couette flow flows on the air bearing surface of the slider 10. In this Couette flow component, the smaller the depth of the concave portion, the larger the speed gradient. In our earlier applications, by installing the first concave portion 11 shallower in depth than the bottom surface 3a of the second concave portion 3, shear stress by the Couette flow component in the downstream direction is promoted. Thereby, stagnation points of shear stresses were eliminated, and an air bearing surface on which lubricant is less prone to stay was formed.

FIG. 6 is a vector diagram illustrating the directions of shear stresses applied to the air bearing surface by air flow when air is delivered from the side of the leading edge 10b of the air bearing surface 10a toward the trailing edge 10c thereof, in the configuration in FIG. 3. Behind the center pad 4 and behind the side pads 6, stagnation points, where lubricant stays, are prone to occur. However, in this case, as illustrated in FIG. 6, it can be seen that no stagnation point occurs. That is, in our earlier application, stagnation points were prevented by forming the concave portions into a two-level configuration and by making the rear side of the side pads 6 the bottom surface 11a of the shallower first concave portion 11. In this way, the first concave portion 11 is designed to have no stagnation points of shear stresses.

As can be seen from the shear stress analysis diagram in FIG. 6, reduction in the depth of the concave portion makes stagnation less prone to occur behind an obstruction, such as the side pads 6, against air flow. However, the depth of the second concave portion 3 is related to a negative pressure generated by the second concave portion 3. In order to generate a moderate negative pressure, a depth to some extent is required. For this purpose, the bottom surface of the concave portion has been formed into a two-level configuration. That is, by causing the deeper second concave portion 3 to generate a required negative pressure, and by installing the shallower first concave portion 11 in the region where the obstruction such as the side pads 6 exists, the occurrence of the stagnation points are prevented.

When such a magnetic head slider is manufactured, generally, a slider body portion is constituted by hard Al₂O₃—TiC (alumina-titanium carbide: AlTiC) material. At the downstream end of the slider body portion, there is provided an Alumina (Al₂O₃) layer in which a read/write element is embedded.

That is, the alumina layer is arranged over an unworked AlTiC substrate, and thereon, a large number of magnetic head elements are formed. Furthermore, by covering surroundings of the magnetic head elements with insulating alumina, a large number of magnetic head elements are formed into an AlTiC substrate shape. Then, this AlTiC substrates is cut into a bar shape, and a bar wherein a plurality of sliders each equipped with a magnetic head are arranged side by side, is produced. On this bar, the above-described concave portions and convex portions of the magnetic head slider are formed by etching, and this bar is cut into individual magnetic head sliders.

That is, in the unworked slider, an alumina layer different from AlTiC exists at the downstream end of the AlTiC body of the slider body.

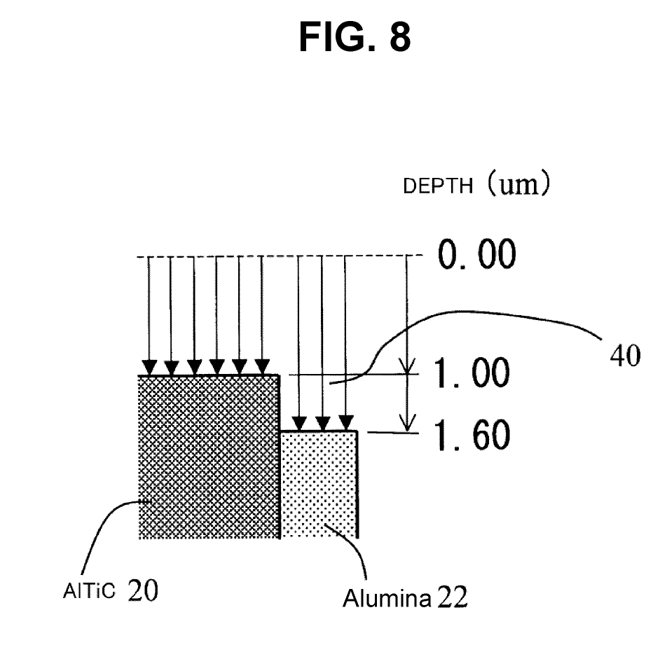

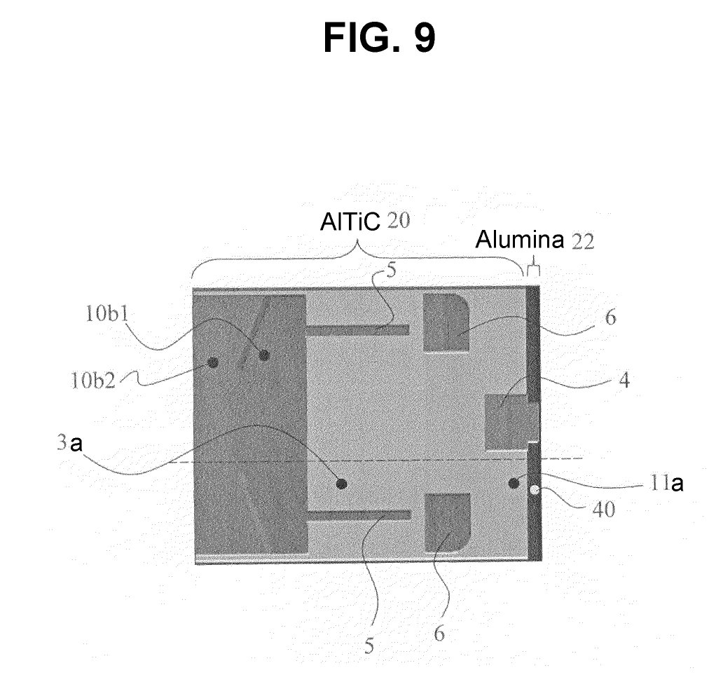

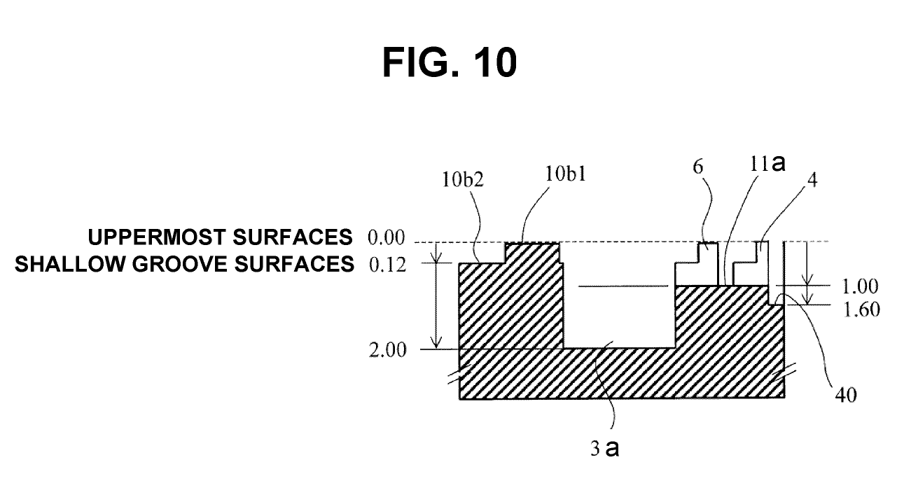

FIGS. 7A to 7D are explanatory views of a manufacturing process of this magnetic head slider; FIG. 8 is an etching process at the downstream end; FIG. 9 is a top view of the magnetic head slider manufactured by the manufacturing method in FIGS. 7A to 7D; and FIG. 10 is a sectional view of FIGS. 7A to 7D along the broken line.

With reference to FIGS. 8 to 10, the manufacturing process in FIGS. 7A to 7D is described. Typically, a series of work is performed in a state wherein a plurality of the sliders laterally continue to each other, but in FIGS. 7A to 7D, a region of only a single slider is illustrated for the convenience of illustration.

In the slider before starting to be worked, an alumina layer 22 in which a magnetic head 30 is formed, is arranged on the downstream end of the slider body (AlTiC) 20 (FIG. 7A). In a process illustrated in FIG. 7B, level-difference working is performed for exposing the shallow groove surfaces formed at a depth of 0.12 μm from the uppermost surfaces. This level-difference working is performed by covering areas that are ultimately to be made the uppermost surfaces (hatching portions in FIG. 7B) with a photo-resist layer having subjected to patterning by photolithography, and by etching regions that are not covered with the photo-resist layer by a method such as ion milling or reactive ion etching (RIE). Surfaces that are ultimately to be made shallow groove surfaces and surfaces to be formed at deeper positions than those of the shallow groove surfaces are simultaneously worked.

In a process illustrated in FIG. 7C, level-difference working is performed for exposing the surface corresponding to the first concave portion 11a (lubricant flow promoting surface), to be formed at a depth of 1 μm from the uppermost surface. This etching is performed so that, in the region corresponding to the first concave portion 11a, a cumulative etching depth obtained by adding the etching depth in the etching performed in the process in FIG. 7B to that in this process in FIG. 7C becomes 1 μm.

The etching in this process is performed by covering areas that are ultimately to be made the uppermost surfaces and the shallow groove surfaces with a photo-resist layer having subjected to patterning by photolithography. The bottom surface 11a of the first concave portion and the region 3a corresponding to the second concave portion (deep groove surface), formed at a deeper position than that of the bottom surface 11a of the first concave portion are simultaneously worked.

Lastly, in a process in illustrated in FIG. 7D, level-difference working for forming the bottom surface 3a is performed. This working is performed so that the cumulative etching depth in the area corresponding to the second concave portion 3 becomes 2 μm with respect to the uppermost surface.

Regarding the above-described manufacturing processes, in the processes illustrated in FIGS. 7B, 7C, and 7D, because the alumina layer 22 corresponding to the downstream end is etched at a higher etching rate than that of the AlTiC 20 as illustrated in FIG. 8, the alumina layer 22 is etched up to a deepness that is 1.6 times deeper than the depth of the AlTiC portion 20. As a result, an unintended third concave portion 40 is formed at the downstream end.

Consequently, as illustrated in FIGS. 9 and 10, the bottom surface 11a of the first concave portion does not reach the downstream end, and the third concave portion 40 is formed. Conventionally, in the design of the air bearing surface, conception concerning the control of the flow or stay of lubricant has not much grown, and the level difference in this portion has not become a major issue. Especially, efforts to eliminate the level difference have not been made.

However, in a design taking the flow or stay of lubricant into account, there is a need to eliminate such a level-difference 40 in the alumina portion at the downstream end. This is because a Courte flow component at the downstream portion is changed by the third concave portion 40.

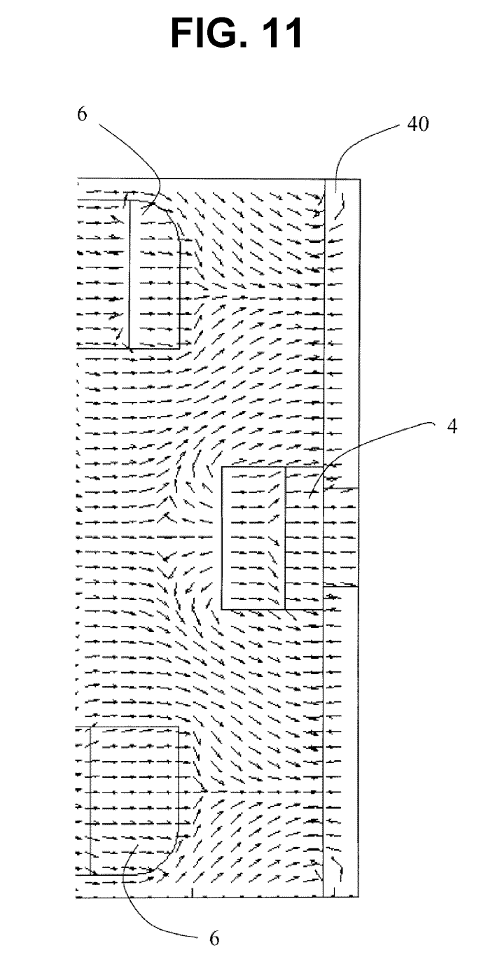

FIG. 11 is a vector diagram illustrating directions of shear stresses applied to the air bearing surface 10a by air flow when air is flowed from the leading edge 10b of the air bearing surface 10a toward the trailing edge 10c thereof, in the magnetic head slider illustrated in FIGS. 7A to 10. In the third concave portion 40, vectors indicating directions of shear stresses are reversed, and the vectors concentrates on the boundary between the bottom surface 11a and the third concave portion 40, so that a pool of lubricant is prone to occur. The depth of the third concave portion 40, or the presence/absence of an occurrence of the stagnation points of shear stresses based on the third concave portion 40 depends upon the etching method, the etching condition, and the air bearing surface shape. However, as in the present embodiment, there can be cases where stagnation points of shear stresses occur and continuous discharge of the lubricant is hindered.

In addition to our previous applications, the present invention implements the prevention of the formation of the third concave portion 40 at the rear end of the first concave portion 11a, thereby further promoting the flow of the lubricant.

### First Embodiment

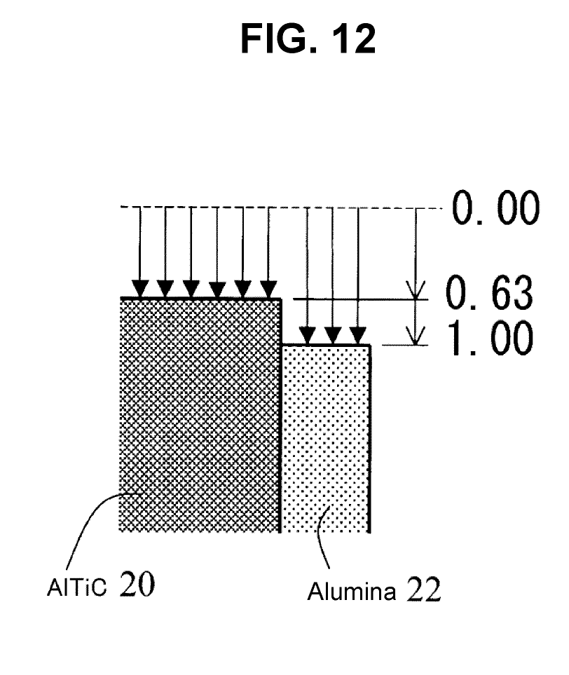

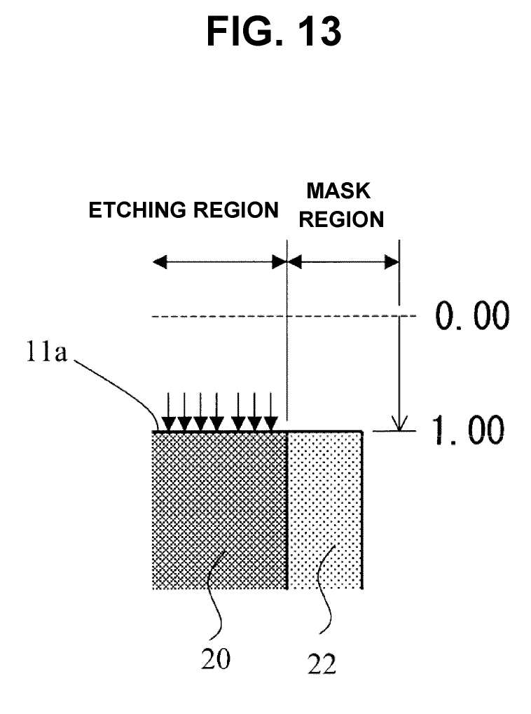

FIGS. 12 and 13 are explanatory views of a first embodiment. A process for forming the first concave portion 11 (FIG. 7C) provided for preventing lubricant pools, is implemented in accordance with the following procedure. First, etching is made down to a depth shallower than a predetermined depth (in FIG. 8, 1.00 μm) by a first etching step, as illustrated in FIG. 12. Then, as illustrated in FIG. 13, a portion including the alumina layer 22 at the downstream end is masked, and the inflow side further than the alumina layer 22 is etched down to the predetermined (1.00 μm) by a second etching step, thus forming the first concave portion 11.

By doing this, the third concave portion 40 formed on the alumina layer 22 has the same depth as that of the first concave portion 11. A mask region illustrated in FIG. 13 is a region that is covered with a photo resist having subjected to patterning by photolithography, and that has been subjected to no etching.

The depth of the third concave portion 40 is not necessarily required to perfectly conform to that of the first concave portion 11, as long as the depth is one such as to cause no stagnation point of shear stress.

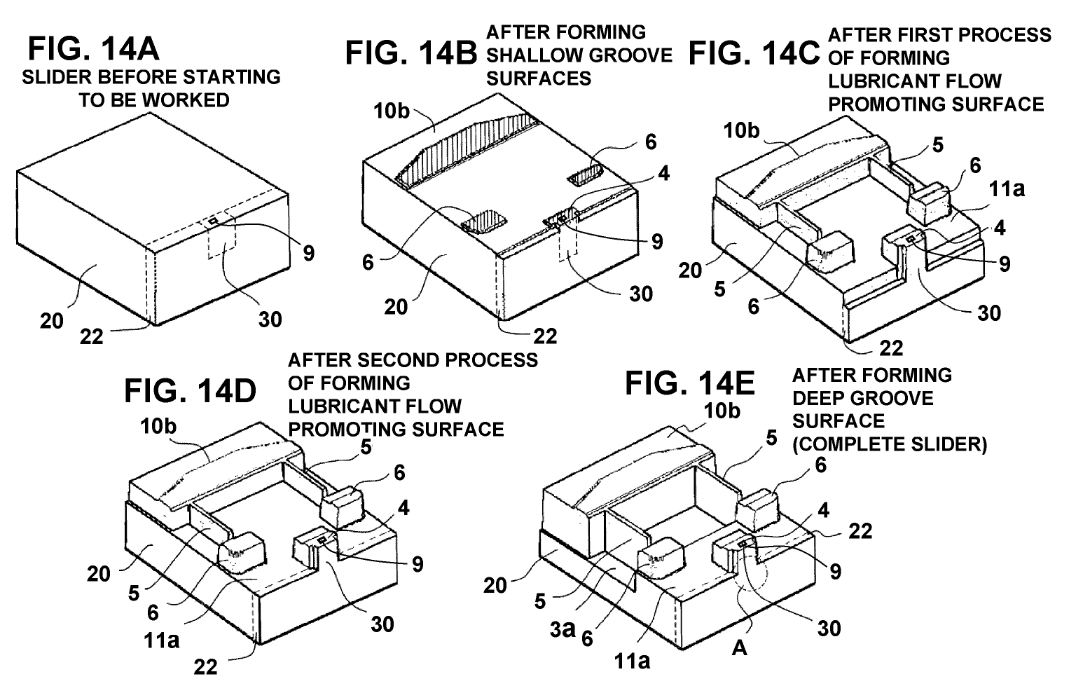

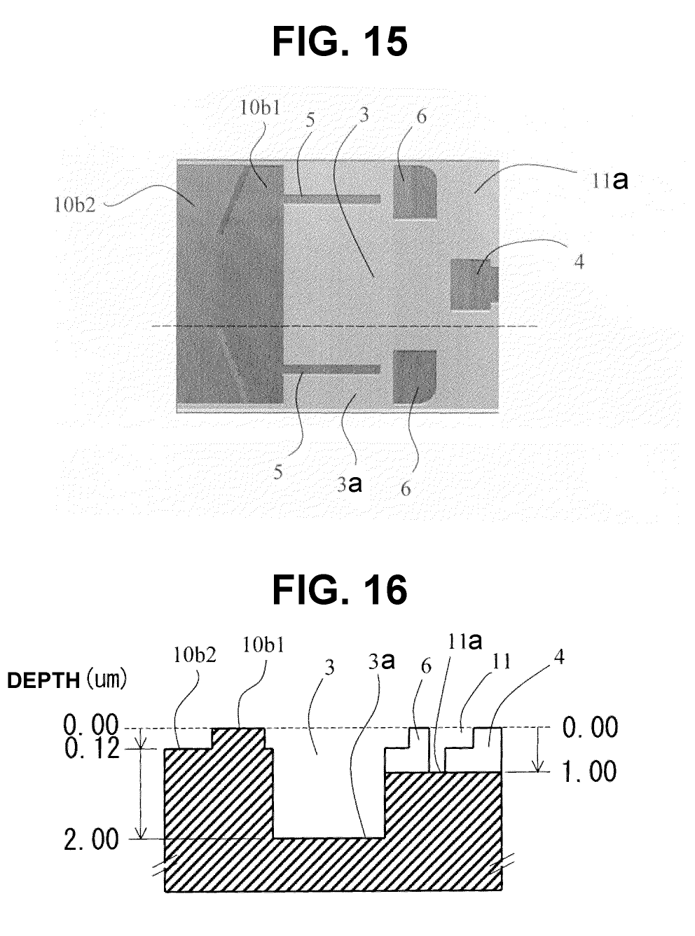

FIGS. 14A to 14E are explanatory views of a manufacturing process of a magnetic head slider according to the first embodiment, wherein the manufacturing process makes use of a principle illustrated in FIG. 13; FIG. 15 is a top view of the magnetic head slider manufactured by the manufacturing method in FIGS. 14A to 14E; and FIG. 16 is a sectional view of FIG. 15 along the broken line.

In the slider before starting to be worked, an alumina layer 22 in which the magnetic head 30 is formed, is arranged at the downstream end of the slider body (AlTiC) 20 (FIG. 14A). In a process illustrated in FIG. 14B, level-difference working is performed for exposing shallow groove surfaces to be formed at a depth of 1.2 μm from the uppermost surfaces. This level-difference working is performed by covering areas that are ultimately to be made the uppermost surfaces (hatching portions in FIG. 14B) with a photo-resist layer having subjected to patterning by photolithography, and by etching regions that are not covered with the photo-resist layer by a method such as ion milling or reactive ion etching (RIE). Surfaces that are ultimately to be made shallow groove surfaces and surfaces to be formed at deeper positions than those of the shallow groove surfaces are simultaneously worked. In this embodiment, the mask region of the center pad 4 extends up to the posteriormost end of the slider.

Next, in a process illustrated in FIG. 14C, a first process of level-difference working is performed for exposing a surface corresponding to the first concave portion 11, to the uppermost surface. As illustrated in FIG. 12, this etching is performed so that, in a region corresponding to the first concave portion 11, a cumulative etching depth obtained by adding the etching depth in the etching performed in the process in FIG. 14B to that in this process in FIG. 14C becomes 0.63 μm. The etching in this process is performed by covering areas that are ultimately to be made the uppermost surfaces and the shallow groove surfaces with a photo-resist layer having subjected to patterning by photolithography. The first concave portion 11 and a region corresponding to the second concave portion 3 to be formed at deeper position than that of the first concave portion 11 are simultaneously worked. As illustrated in FIG. 12, at this time, the alumina layer 22 at the downstream end, other than the center pad 4 has a depth of 1 μm due to the difference in etching rate from that of the AlTiC 20.

A process illustrated in FIG. 14D is a second process for forming the first concave portion 11, and a process for adjusting the depth of the first concave portion 11 and a region to be formed at a deeper position that of the first concave portion 11, to 1 μm with respect to the uppermost surface. As illustrated in FIG. 13, the etching is performed by covering the alumina layer 22 at the downstream portion besides the regions that are ultimately to be made the uppermost surfaces and the shallow groove surfaces, with a photo-resist layer having subjected to patterning by photolithography, in addition to regions that are ultimately to be made the uppermost surfaces and the shallow groove surfaces. By these processes in FIGS. 14C and 14D, the level-difference in the alumina layer 22 is eliminated.

Lastly, in a process in FIG. 14E, a level-difference working for forming the bottom surface 3a is performed. This working is performed so that the cumulative etching depth corresponding to the second concave portion 3 becomes 2 μm from the uppermost surface.

As a consequence, a slider as illustrated in FIGS. 15 and 16 is completed. That is, on the alumina layer 22 at the downstream end, no deep portion is formed. This allows stay of the lubricant to be less prone to occur.

As illustrated in FIGS. 14A to 16, the surface of the center pad 4 on the downstream end side is flush with the downstream end surface of the slider forming the first concave portion 11 of the slider. This is indicated by a dot line portion A in FIG. 14E. In the configuration in our applications, a part of the first concave portion 11a exists on the downstream end side of the center pad 4. As a result, in our application, stay of lubricant is prone to occur on the downstream end side of the center pad 4.

In this embodiment, since the surface of the center pad 4 on the downstream end side is flush with the slider downstream end surface forming the first concave portion 11 of the slider, it is possible to more reliably prevent stay of the lubricant from occurring. However, it is not an indispensable condition that the surface of the center pad 4 on the downstream end side is flush with the downstream end surface of the slider.

### Second Embodiment

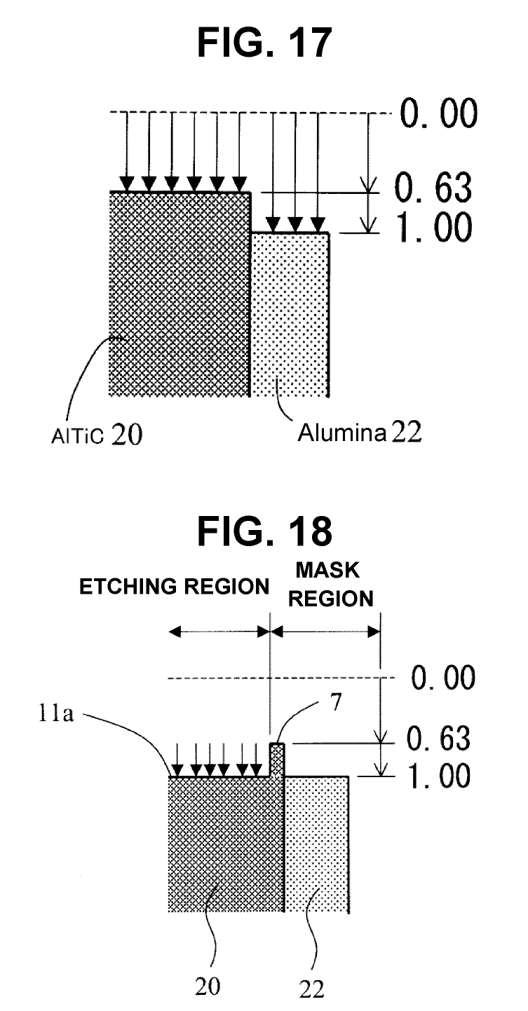

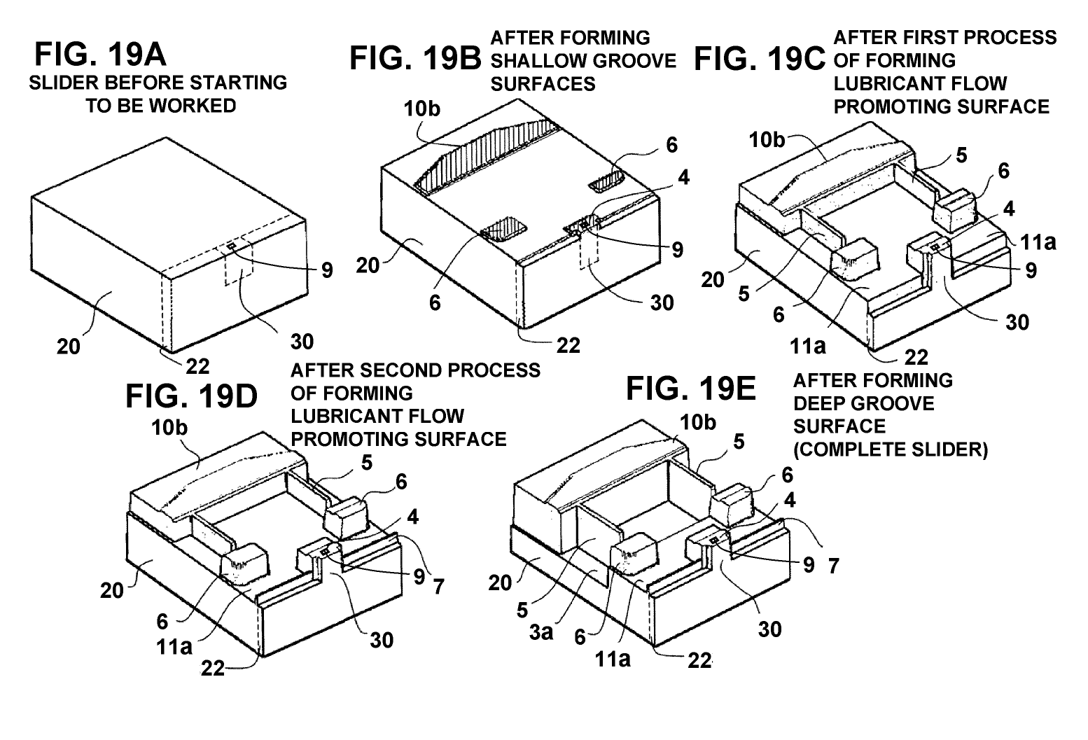

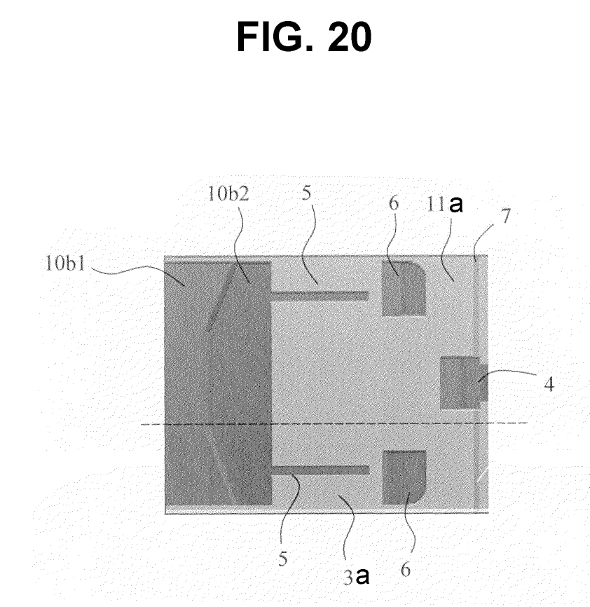

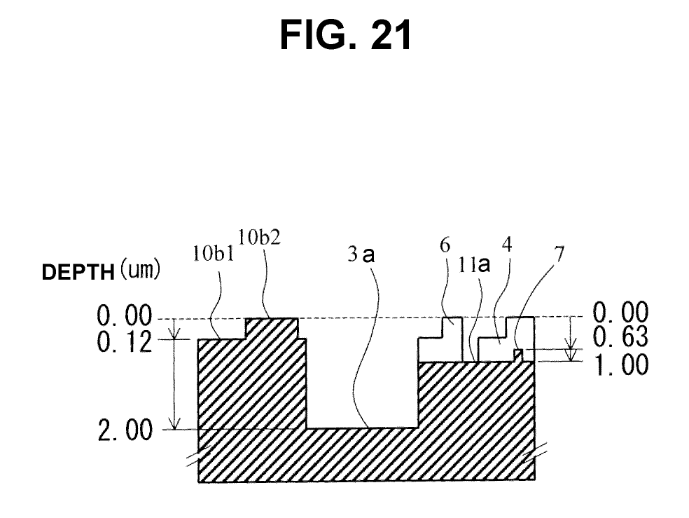

FIGS. 17 and 18 are explanatory views of a second embodiment. FIGS. 19A to 19E are explanatory views of a manufacturing process of a magnetic head slider according to the second embodiment, wherein the manufacturing process makes use of a principle illustrated in FIGS. 17 and 18. FIG. 20 is a top view of a magnetic head slider manufactured by the manufacturing method in FIGS. 19A to 19E, and FIG. 21 is a sectional view of FIG. 20 along the broken line.

As in the case of the first embodiment, in the second embodiment, a process for forming the first concave portion 11 (FIG. 7C) provided for preventing lubricant pools, is implemented in accordance with the following procedure. First, etching is made down to a depth shallower than a predetermined depth (in FIG. 8, 1.00 μm) by a first etching step, as illustrated in FIGS. 17 and 19C. Then, as illustrated in FIGS. 18 and 19D, a portion including the alumina layer 22 at the downstream end is masked, and the inflow side further than the alumina layer 22 is etched down to the predetermined (1.00 μm) by a second etching step, thus forming the first concave portion 11.

As illustrated in FIG. 18, the second embodiment is different from the first embodiment in that, in the second etching step, the mask region partly enters the AlTiC 20. By tolerating this overlying, mask alignment accuracy in the photolithography can be alleviated.

As a consequence, as illustrated in FIGS. 18, 19D, 19E, 20 and 21, in the vicinity of the boundary between the AlTiC 20 and the alumina layer 22, there is provided the ridge 7 higher than the first concave portion 11. Here, FIGS. 19A to 19E correspond to FIGS. 14A to 14E. The difference between the processes in FIGS. 19A to 19E and the processes in FIGS. 14A to 14E lies in that, for the process in FIG. 19D, the second process in FIG. 14D is adopted. Thereby, in the vicinity of the boundary between the AlTiC 20 and the alumina layer 22, the ridge 7 higher than the first concave portion 11 is formed.

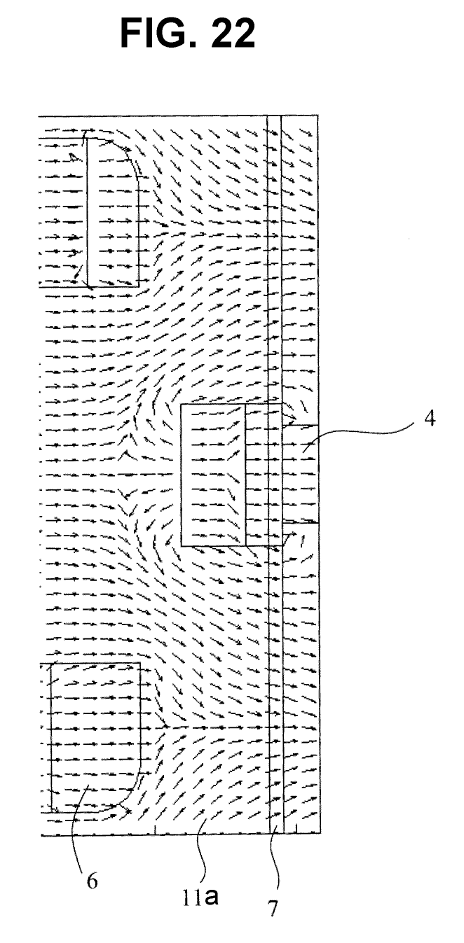

FIG. 22 is a vector diagram illustrating directions of shear stresses applied to the air bearing surface 10a by air flow when air is flowed from the leading edge 10b of the air bearing surface 10a toward the trailing edge 10c thereof, in the magnetic head slider illustrated in FIGS. 20 and 21.

As illustrated in FIG. 22, it can be ascertained by simulation that the lubricant adhered to the first concave portion 11 is discharged overriding this ridge 7 by shear flow of air.

That is, at the protruded portion 7 formed at the boundary between the AlTiC 20 and the alumina 22, the shear stress of the Couette flow component increases, so that the attached lubricant is discharged overriding the protruded portion 7.

As in the case of the first embodiment, in the second embodiment, since no deep portion is formed in the alumina layer 22, it is possible to make the stay of the lubricant less prone to occur. Furthermore, since the surface of the center pad 4 on the downstream end side is flush with the slider downstream end face forming the first concave portion 11 of the magnetic disk 2, it is possible to more effectively prevent stay of lubricant from occurring on the downstream end side.

Moreover, it is possible to alleviate mask aligning accuracy in photolithography.

### Third Embodiment

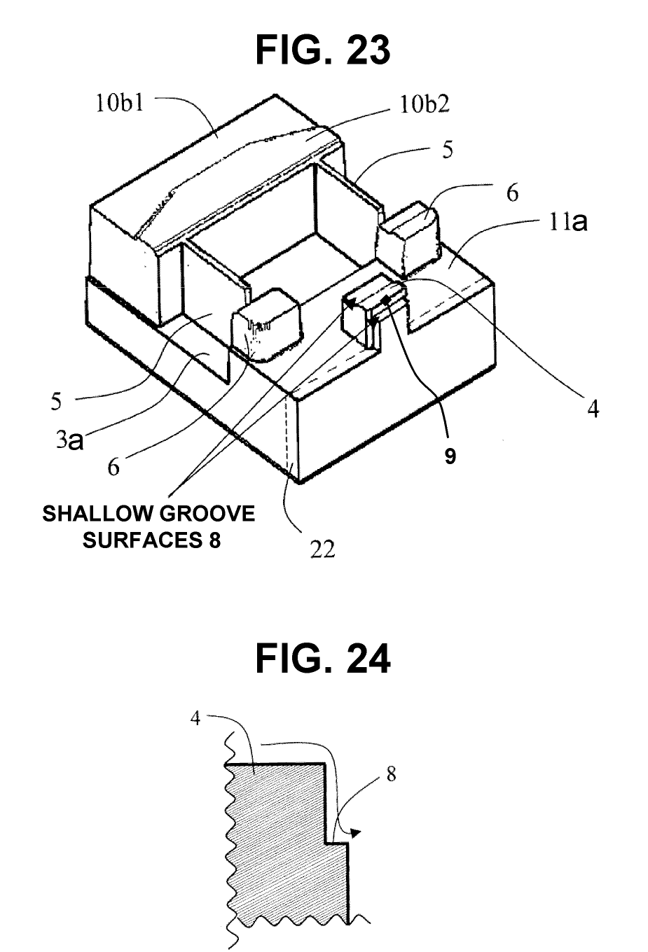

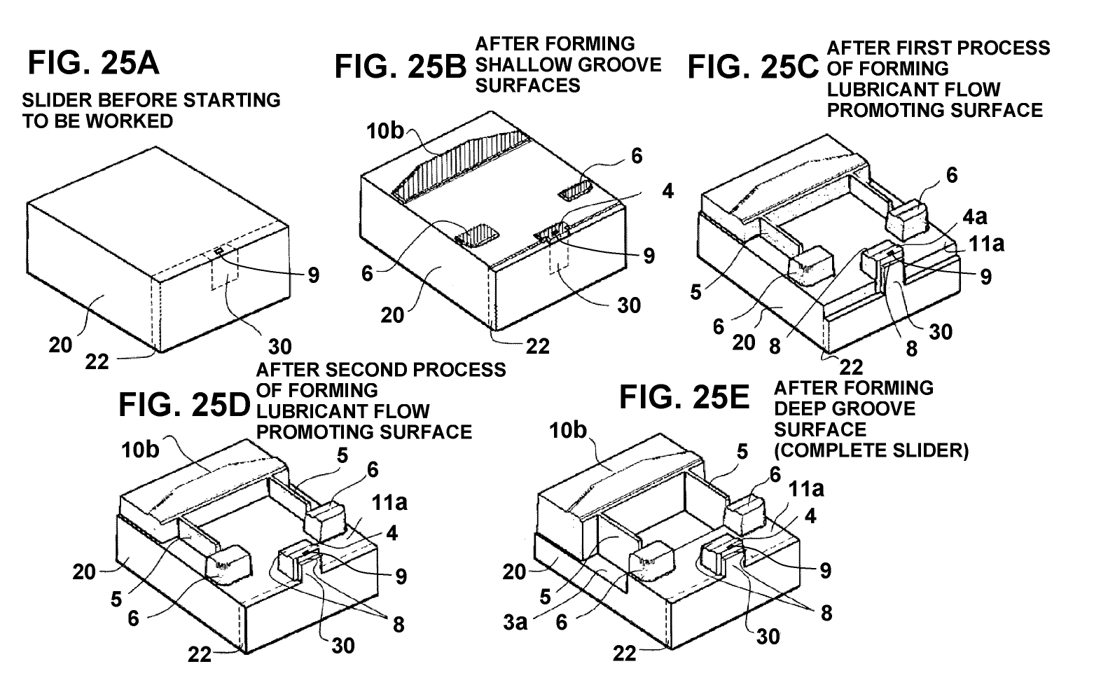

FIG. 23 is a perspective view of a magnetic head slider according to a third embodiment, FIG. 24 is an explanatory of operations thereof, and FIGS. 25A to 25E are explanatory views of a manufacturing process of a magnetic head slider according to a third embodiment.

In FIG. 23, the same components as those in FIGS. 12 to 21 is designated by the same symbols. In the configuration illustrated in FIG. 23, its difference from the configuration illustrated in FIGS. 14 to 16 lies in that a shallow groove surface 8 is formed on the downstream end side of the outermost surface of the center pad 4.

As illustrated in FIG. 2, the slider 10 has a flying attitude such as to make its closest approach to the surface of the magnetic disk 2 at the downstream end. That is, the uppermost surface of the center pad 4 of the slider makes its closest approach to the surface of the magnetic disk 2. This is effective in preventing a contact of the slider 10 with the magnetic disk surface at its downstream end by forming the shallow groove surface 8 on the downstream end side of the uppermost surface of the center pad 4.

Even though such a configuration is used, as illustrated in FIG. 24, on a place near the magnetic disk surface, since shear stress of Couette flow component is sufficiently high, the lubricant on the uppermost surface of the slider is smoothly discharged.

Processes in the third embodiment as illustrated in FIGS. 25A to 25E correspond to the processes illustrated in FIGS. 14A to 14E. In the processes in FIGS. 25A to 25E, its difference from the processes in FIGS. 14A to 14E lies in that, in the shallow groove forming process in FIG. 19B, a shallow groove is formed at the downstream end of the center pad 4 with the downstream end of the mask region cleared.

As a result, as illustrated in FIG. 23, the shallow groove surface 8 can be formed on the downstream end side of the uppermost surface of the center pad 4. As in the case of the first embodiment, in the third embodiment, since no deep portion is formed in the alumina layer 22, it is possible to make the stay of the lubricant less prone to occur. Furthermore, since the surface of the center pad 4 on the downstream end side is flush with the slider downstream end face forming the first concave portion 11 of the magnetic disk 2, it is possible to more reliably prevent the lubricant from staying on the downstream end side.

### Other Embodiments

The manufacturing processes in FIGS. 14A to 14E, 19A to 19E, and 25A to 25E were each described by way of example. The order of etching for forming surfaces is not limited to these orders. The order of etching may be rearranged as appropriate. The surfaces in the present invention have only to include uppermost surfaces, shallow groove surfaces, a lubricant flow promoting surface, and a deep grove surface by a requisite minimum. Sliders having other surfaces would also be effective. Furthermore, although the material of the slider body has been described to be AlTiC, and the insulating layer has been described to be Alumina, other materials may be used.

Furthermore, in the above-described embodiments, although the side pads 6 are provided on both sides of the air bearing surface in order to stabilizing the posture of the head slider, the side pads 6 are not necessarily required to be installed.

According to the present invention, it is possible to inhibit the occurrence of stagnation points, which are regions on which shear stresses acting on the air bearing surface of the head slider due to air flow concentrate, and to continuously discharge the lubricant toward the trailing edge before the lubricant stays at the stagnation points and grow into a lump-shaped liquid drop. Furthermore, in order to prevent the formation of a level-difference in the insulating layer at the downstream end of the slider, the lubricant is made less prone to stay, whereby it is possible to prevent staying lubricant from growing into a considerably large lump and dropping onto the magnetic recording medium to thereby cause a trouble that impairs reliability. As a result, the influence of a liquid drop of the lubricant upon the flying property of the head slider can be reduced, and the head slider can be prevented from a failure due to collision against liquid drops.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic head slider including a magnetic head element for reading or writing data from or into a magnetic recording medium, the magnetic head slider flying over the magnetic recording medium by an air flow generated by rotation of the magnetic recording medium, the magnetic head slider comprising:
a slider substrate including a center pad for supporting the magnetic head element, the center pad having a sliding surface opposing the magnetic recording medium and a side surface at a downstream side of the air flow, the slider substrate including a concave portion having a bottom surface recessed from the sliding surface; and
an insulating layer covering the side surface of the slider substrate, the insulating layer having an edge surface adjacent to the bottom surface of the concave portion, the edge surface having substantially the same plane with the bottom surface of the concave portion.

2. The magnetic head slider according to claim 1, wherein the slider substrate further includes a ridge portion adjacent to the center pad, extending in the direction crossing the downstream direction of the air flow, the ridge portion having a second sliding surface higher than the bottom surface.

3. The magnetic head slider according to claim 1, wherein the insulating layer includes a groove on the downstream end side of the center pad recessed from the sliding surface, the groove having a second edge surface higher than the edge surface.

4. The magnetic head slider according to claim 1, wherein the center pad is placed at a center of the concave portion, in a direction perpendicular to an downstream direction of the air flow.

5. The magnetic head slider according to claim 1, wherein the slider substrate includes a second concave portion having a second bottom surface recessed from the second bottom surface.

6. The magnetic head slider according to claim 5, wherein the slider substrate includes a pair of side wall portions placed on the second concave portion.

7. The magnetic head slider according to claim 1, wherein the slider substrate includes a pair of side pads on the concave portion in a direction perpendicular to the downstream direction of the air flow.

8. A manufacturing method for a magnetic head slider including a magnetic head element for reading or writing data from or into a magnetic recording medium, the magnetic recording medium by an air flow generated by rotation of the magnetic recording medium, the manufacturing method comprising:
etching a slider substrate having a side surface at a downstream side of the air flow and an insulating layer provided on the side surface of the slider substrate so that a center pad for supporting the magnetic head element on the slider substrate, a concave portion on the slider substrate, and a second concave portion on the insulating layer are formed, the center pad having a sliding surface opposing the magnetic recording medium, the concave portion having a bottom surface recessed from the sliding surface, the second concave portion having a edge surface recessed from the bottom surface, and
etching the concave portion of the slider substrate while the insulating layer is masked so that the bottom surface has substantially the same plane with the edge surface.

9. The manufacturing method for a magnetic head slider according to claim 8, wherein the etching of the concave portion of the slider substrate is carried out while a part of the slider substrate is further masked so that a ridge portion adjacent to the center pad is further formed, the ridge portion extending in the direction crossing the downstream direction of the air flow and being higher than the first and the second concave portion.

10. The manufacturing method for a magnetic head slider according to claim 8, further comprising etching the insulating layer so that a groove on the downstream end side of the center pad is formed, the groove having a second edge surface higher than the edge surface.

11. The manufacturing method for a magnetic head slider according to claim 8, wherein the center pad are placed at a center of the concave portion, in a direction perpendicular to an downstream direction of the air flow.

12. The manufacturing method for a magnetic head slider according to claim 8, further comprising etching a part of the concave portion so as to form a second concave portion deeper than the concave portion.

13. A magnetic disk device comprising:
a magnetic recording medium; and
a magnetic head slider including a magnetic head element for reading or writing data from or into the magnetic recording medium, the magnetic head slider flying over the magnetic recording medium by an air flow generated by rotation of the magnetic recording medium, the magnetic head slider including:
a slider substrate including a center pad for supporting the magnetic head element, the center pad having a sliding surface opposing the magnetic recording medium and a side surface at a downstream side of the air flow, the slider substrate including a concave portion having a bottom surface recessed from the sliding surface; and
an insulating layer covering the side surface of the slider substrate, the insulating layer having an edge surface adjacent to the bottom surface of the concave portion, the edge surface having substantially the same plane with the bottom surface of the concave portion.

14. The magnetic disk device according to claim 13, the slider substrate further includes a ridge portion adjacent to the center pad, extending in the direction crossing the downstream direction of the air flow, the ridge portion having a second sliding surface higher than the bottom surface.

15. The magnetic disk device according to claim 13, wherein the insulating layer includes a groove on the downstream end side of the center pad recessed from the sliding surface, the groove having a second edge surface higher than the edge surface.

16. The magnetic disk device according to claim 13, wherein the center pad is placed at a center of the concave portion, in a direction perpendicular to an downstream direction of the air flow.

17. The magnetic disk device according to claim 13, wherein the slider substrate includes a second concave portion having a second bottom surface recessed from the second bottom surface.

18. The magnetic disk device according to claim 17, wherein the slide substrate includes a pair of side wall portions placed on the second concave portion.

19. The magnetic disk device according to claim 13, wherein the slider substrate includes a pair of side pads on the concave portion in a direction perpendicular to the downstream direction of the air flow.

20. The magnetic head slider according to claim 1, wherein the insulating layer has a side end surface at the downstream end of the air flow, the side end surface of the insulating layer being substantially as large as the side surface of the slider substrate, the insulating layer having a constant dimension in the direction of the air flow.
